(19) United States
(12) Patent Application Publication
(10) Pub. No.: US 2024/0290528 A1
(43) Pub. Date: Aug. 29, 2024

(54) MAGNETIZING DEVICE AND MAGNETIZING METHOD

(71) Applicant: HONDA MOTOR CO., LTD., Tokyo (JP)

(72) Inventors: Toshitaka Kato, Wako-shi (JP); Shinji Nemoto, Wako-shi (JP); Tokio Taira, Wako-shi (JP)

(21) Appl. No.: 18/439,780

(22) Filed: Feb. 13, 2024

(30) Foreign Application Priority Data
Feb. 24, 2023 (JP) 2023-027102

(51) Int. Cl. H01F 13/00; H02K 15/03

(52) U.S. Cl. CPC H01F 13/003; H02K 15/03

(57) ABSTRACT

In a magnetizing device and a magnetizing method, with respect to a fourth magnetic body, a first auxiliary coil allows passage of a diametrical inwardly directed first auxiliary magnetic flux caused by a first auxiliary magnetic field. With respect to a fifth magnetic body, a second auxiliary coil allows passage of a diametrical inwardly directed second auxiliary magnetic flux caused by a second auxiliary magnetic field.

### CROSS-REFERENCE TO RELATED APPLICATIONS

This application is based upon and claims the benefit of priority from Japanese Patent Application No. 2023-027102 filed on Feb. 24, 2023, the contents of which are incorporated herein by reference.

### BACKGROUND OF THE INVENTION

### Field of the Invention

The present invention relates to a magnetizing device and a magnetizing method.

### Description of the Related Art

In recent years, efforts directed toward realizing a low-carbon or a decarbonized society have become more active. In respect to vehicles as well, research and development in relation to electrification technology are also being conducted in order to reduce CO2 emissions and to improve energy efficiency. For this reason, electric vehicles, which do not emit greenhouse gases and are superior in terms of environmental performance, are attracting attention. An electric vehicle is equipped with a high-output motor as a drive source. Further, electrification of aircraft and work equipment is being promoted, and in the field of general-purpose equipment, replacement of engines with motors is being promoted.

Among such motors, a PM motor having permanent magnets in its rotor is said to be superior in efficiency and environmental performance. The rotor used for such a motor has a magnetization process for magnetizing the permanent magnets at a final stage of the manufacturing process. For example, JP 2005-224055 A discloses a magnetizing device and a magnetizing method for multipole permanent magnets arranged alongside one another in a rotor.

### SUMMARY OF THE INVENTION

In order to reduce the size and increase the output of the motor, research aimed at reducing the diameter and increasing the rotational speed of the motor is advancing to contribute to the improvement in energy efficiency. A high-rotation type motor may have a scattering prevention sleeve around the rotor in order to prevent deformation of the rotor and to prevent scattering of the magnets due to centrifugal force. In this case, an air gap between the stator and the rotor is widened, resulting in the magnetization thereof being affected. In addition, the rotor structure is changing because of the appearance of an SPM type motor, in which the magnets are arranged outside of the rotor, an attempt to produce a higher output with a Halbach arrangement of the magnets, an improvement in the performance of the magnets, and an increase in the number of poles. A rotor having a smaller diameter and a greater number of poles leads to a smaller magnetic circuit for magnetizing the permanent magnets, and causes a problem in that the magnetic flux hardly reaches the inside of the permanent magnets. Further, the improvement in the performance of the magnets increases the magnetic field intensity required to magnetize the magnets, and requires a magnetizing magnetic field of higher intensity. As described above, there has appeared a rotor that is difficult to magnetize by means of a conventional magnetizing device.

As a countermeasure against such problems, it may be considered to ensure the necessary magnetic field intensity by increasing the power supply capacity and the electrical current flowing through the magnetizing coils. However, such an increase in the electrical current results in a shortening of the product lifetime of the magnetizing coils, together with an increase in investment in power supply equipment, thereby increasing manufacturing costs.

An object of the present invention is to solve the aforementioned problems.

A first aspect of the present invention is characterized by a magnetizing device configured to magnetize a plurality of magnetic bodies, by applying, with respect to a rotor having the plurality of magnetic bodies arranged in a circumferential direction, a magnetic field in a diametrical direction of the rotor, the magnetizing device comprising a first magnetizing coil arranged in facing relation to an outer circumferential surface of the rotor, and configured to cause a diametrical outwardly directed first magnetic field to be generated, a second magnetizing coil arranged in facing relation to the outer circumferential surface of the rotor, and configured to cause a diametrical inwardly directed second magnetic field to be generated, a third magnetizing coil arranged in facing relation to the outer circumferential surface of the rotor, and configured to cause a diametrical inwardly directed third magnetic field to be generated, a first auxiliary coil arranged between the first magnetizing coil and the second magnetizing coil in facing relation to the outer circumferential surface of the rotor, and configured to cause a diametrical inwardly directed first auxiliary magnetic field to be generated, and a second auxiliary coil arranged between the first magnetizing coil and the third magnetizing coil in facing relation to the outer circumferential surface of the rotor, and configured to cause a diametrical inwardly directed second auxiliary magnetic field to be generated, wherein, by the first magnetizing coil drawing in with the first magnetic field a composite magnetic field which is a composite of the second magnetic field and the third magnetic field, among the plurality of magnetic bodies, a first magnetic body facing toward the first magnetizing coil is magnetized in a diametrical outward direction, a second magnetic body facing toward the second magnetizing coil is magnetized in a diametrical inward direction, and a third magnetic body facing toward the third magnetizing coil is magnetized in a diametrical inward direction, among magnetic fluxes caused by the second magnetic field and the third magnetic field, a magnetic flux that is not drawn in by the first magnetic field is a diametrical outwardly directed leakage magnetic flux, on both sides of the first magnetic body along the circumferential direction, a fourth magnetic body and a fifth magnetic body are adjacent to the first magnetic body while sandwiching the first magnetic body therebetween, with respect to the fourth magnetizing body, the first auxiliary coil allows passage of a diametrical inwardly directed magnetic flux caused by the first auxiliary magnetic field, and with respect to the fifth magnetizing body, the second auxiliary coil allows passage of a diametrical inwardly directed magnetic flux caused by the second auxiliary magnetic field.

A second aspect of the present invention is characterized by a magnetizing method of magnetizing a plurality of magnetic bodies, by applying, with respect to a rotor having the plurality of magnetic bodies arranged in a circumferential direction, a magnetic field in a diametrical direction of the rotor, the magnetizing method comprising an arrangement step of arranging a first magnetizing coil, a second magnetizing coil, a third magnetizing coil, a first auxiliary coil, and a second auxiliary coil in facing relation to an outer circumferential surface of the rotor, and a magnetizing step in which, by causing a diametrical outwardly directed first magnetic field to be generated, causing a diametrical inwardly directed second magnetic field to be generated, and causing a diametrical inwardly directed third magnetic field to be generated, and by the first magnetizing coil drawing in with the first magnetic field a composite magnetic field which is a composite of the second magnetic field and the third magnetic field, among the plurality of magnetic bodies, a first magnetic body facing toward the first magnetizing coil is magnetized in a diametrical outward direction, a second magnetic body facing toward the second magnetizing coil is magnetized in a diametrical inward direction, and a third magnetic body facing toward the third magnetizing coil is magnetized in a diametrical inward direction, in the arrangement step, on both sides of the first magnetic body along the circumferential direction, a fourth magnetic body and a fifth magnetic body are placed adjacent to the first magnetic body while sandwiching the first magnetic body therebetween, among magnetic fluxes caused by the second magnetic field and the third magnetic field, a magnetic flux that is not drawn in by the first magnetic field is a diametrical outwardly directed leakage magnetic flux, with respect to the fourth magnetizing body, the first auxiliary coil allows passage of a diametrical inwardly directed magnetic flux caused by the first auxiliary magnetic field, and with respect to the fifth magnetizing body, the second auxiliary coil allows passage of a diametrical inwardly directed magnetic flux caused by the second auxiliary magnetic field.

According to the present invention, since the composite magnetic field in which the second magnetic field and the third magnetic field are combined is drawn in by the first magnetic field, a high intensity magnetic field reaches the interior of the first magnetic body to the third magnetic body of the rotor. Consequently, at a low cost, it is possible to magnetize the interior of the first magnetic body to the third magnetic body.

Further, at a time when the first magnetic field draws in the composite magnetic field which is a composite of the second magnetic field and the third magnetic field, the magnetic flux that is not drawn in by the first magnetic field becomes the diametrical outwardly directed leakage magnetic flux. The fourth magnetic body and the fifth magnetic body are adjacent to both sides of the first magnetic body along the circumferential direction. Therefore, when the leakage magnetic flux passes through the fourth magnetic body and the fifth magnetic body, there is a possibility that the fourth magnetic body and the fifth magnetic body may be magnetized in a direction opposite to the original magnetizing direction (the diametrical inward direction).

Thus, according to the present invention, among the plurality of magnetic bodies, the diametrical inwardly directed magnetic flux caused by the first auxiliary magnetic field or the second auxiliary magnetic field is allowed to pass with respect to the fourth magnetic body and the fifth magnetic body which are capable of being magnetized in a direction opposite to the original magnetizing direction. Consequently, the leakage magnetic flux passes through the interior of the rotor in a manner so as to avoid the diametrical inwardly directed magnetic flux that passes through the fourth magnetic body and the fifth magnetic body. As a result, it is possible to avoid a situation in which the fourth magnetic body and the fifth magnetic body are magnetized in a direction opposite to the original magnetizing direction. Further, by avoiding the fourth magnetic body and the fifth magnetic body, the leakage magnetic flux becomes capable of being drawn into the first magnetic field.

Therefore, according to the present invention, while causing the first magnetic body to the third magnetic body in the interior of the rotor to be magnetized, it is possible to suppress a situation in which the fourth magnetic body and the fifth magnetic body are magnetized in a direction opposite to the original magnetizing direction due to the leakage magnetic flux.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of a magnetizing device according to the present embodiment;

FIG. 2 is a perspective view of a rotor, a first magnetizing coil, a second magnetizing coil, a third magnetizing coil, a first auxiliary coil, and a second auxiliary coil;

FIG. 3 is a diagram showing a magnetic field distribution of the magnetizing device according to the present embodiment;

FIG. 4 is a diagram schematically showing connections of the first magnetizing coil, the second magnetizing coil, the third magnetizing coil, the first auxiliary coil, and the second auxiliary coil in the magnetizing device shown in FIG. 1 to FIG. 3;

FIG. 5 is a flowchart showing a magnetizing method according to the present embodiment;

FIG. 6 is a view showing a magnetic field distribution of a magnetizing device according to a first comparative example;

FIG. 7 is a view showing a magnetic field distribution of a magnetizing device according to a second comparative example;

FIG. 8 is a perspective view of a magnetizing device according to a third comparative example;

FIG. 9 is a view showing a magnetic field distribution of a magnetizing device according to the third comparative example;

FIG. 10 is a diagram schematically showing connections of the first magnetizing coil and an auxiliary coil in the magnetizing device shown in FIG. 9;

FIG. 11 is a perspective view of a magnetizing device according to an exemplary modification of the present embodiment;

FIG. 12 is a diagram showing a magnetic field distribution of the magnetizing device according to the exemplary modification of the present embodiment; and

FIG. 13 is a diagram schematically showing connections of the first magnetizing coil, the second magnetizing coil, the third magnetizing coil, the first auxiliary coil, and the second auxiliary coil in the magnetizing device shown in FIG. 11 and FIG. 12.

### DETAILED DESCRIPTION OF THE INVENTION

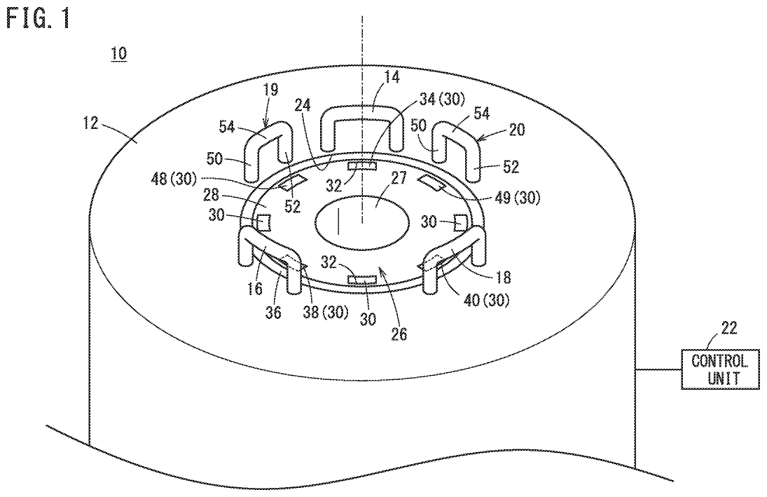

FIG. 1 is a perspective view of a magnetizing device 10 according to the present embodiment.

The magnetizing device 10 according to the present embodiment is equipped with a magnetizing yoke 12, a first magnetizing coil 14, a second magnetizing coil 16, a third magnetizing coil 18, a first auxiliary coil 19, a second auxiliary coil 20, and a control unit 22.

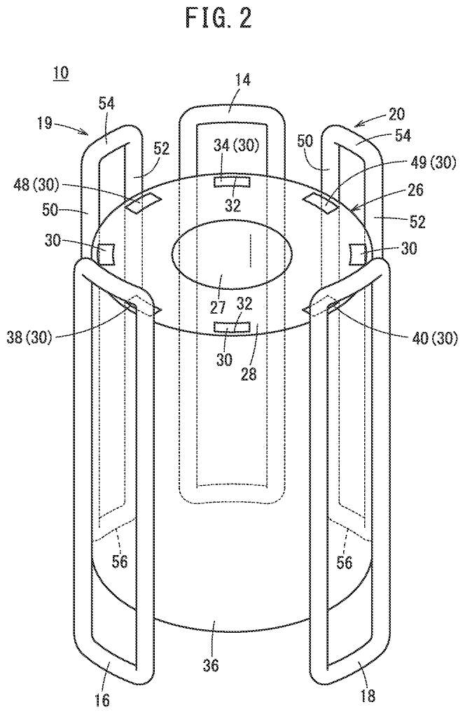

The magnetizing yoke 12 is a cylindrically shaped yoke. A hollow part 24 is formed in a central portion of the magnetizing yoke 12. The hollow part 24 is formed along an axial direction of the magnetizing yoke 12. A cylindrically shaped rotor 26 (refer to FIG. 2) is accommodated in the hollow part 24. In a central portion of the rotor 26, a hollow part 27 is formed into which a non-illustrated shaft is inserted. As shown in FIG. 1, the rotor 26 is accommodated in the hollow part 24 along the axial direction of the magnetizing yoke 12. The inner diameter of the hollow part 24 is slightly larger than the outer diameter of the rotor 26.

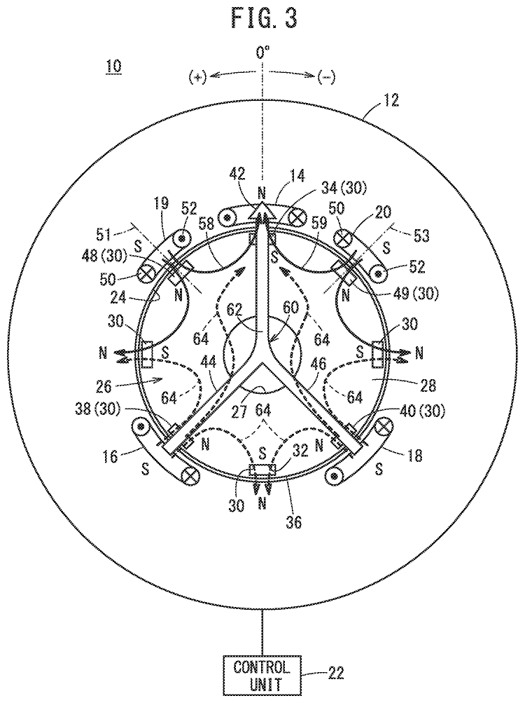

The rotor 26 is used for a PM motor, for example. The rotor 26 includes a rotor main body 28 and a plurality of magnetic bodies 30. The rotor main body 28 is a cylindrically shaped member made of a soft magnetic material. A plurality of accommodation holes 32 are formed on an outer circumferential side of the rotor main body 28. The plurality of accommodation holes 32 are formed at an equal interval in the circumferential direction of the rotor main body 28. Each of the plurality of accommodation holes 32 passes in the axial direction through the rotor main body 28. Moreover, as shown in FIG. 3, according to the present embodiment, an angular position at which a first magnetic body 34 and the first magnetizing coil 14 are arranged is 0°. Further, as shown in FIG. 3, according to the present embodiment, a counterclockwise direction around a central axial line of the rotor 26 and the magnetizing yoke 12 is a positive circumferential direction of the rotor 26. Furthermore, in FIG. 3, the X markings and the dots illustrated on the first magnetizing coil 14, the second magnetizing coil 16, the third magnetizing coil 18, the first auxiliary coil 19, and the second auxiliary coil 20 indicate the direction of the electrical current.

The magnetic bodies 30 are inserted into each of the plurality of accommodation holes 32. Each of the plurality of magnetic bodies 30 is fixed to the rotor main body 28 by being sealed by means of a non-illustrated resin in a state of being inserted into the accommodation holes 32. The plurality of magnetic bodies 30 are magnetic bodies that serve as objects to be magnetized by the magnetizing device 10. The plurality of magnetic bodies 30 are hard magnetic bodies. The plurality of magnetic bodies 30 become permanent magnets due to being magnetized by the magnetizing device 10. The rotor main body 28 and both ends of the plurality of magnetic bodies 30 are covered with a non-illustrated reinforcing layer made of a carbon fiber composite material or the like.

According to the present embodiment, for example, eight of the accommodation holes 32 are formed in the rotor main body 28. Specifically, as viewed in plan, the eight accommodation holes 32 are formed at an interval of 45° in the circumferential direction of the rotor 26 (refer to FIG. 3). Accordingly, eight individual magnetic bodies 30 are accommodated in the rotor main body 28 at an interval of 45° in the circumferential direction of the rotor 26. The rotor 26 may be used for an SPM motor. Further, the number of the magnetic bodies 30 (the number of poles of the rotor 26) is not limited to being eight.

The first magnetizing coil 14, the second magnetizing coil 16, and the third magnetizing coil 18 are arranged in close proximity to the hollow part 24 in the magnetizing yoke 12. The first magnetizing coil 14, the second magnetizing coil 16, and the third magnetizing coil 18 are arranged at predetermined angles in the circumferential direction of the magnetizing yoke 12. As shown in FIG. 2 and FIG. 3, each of the first magnetizing coil 14, the second magnetizing coil 16, and the third magnetizing coil 18 is disposed in facing relation to an outer circumferential surface 36 of the rotor 26 (the rotor main body 28) so that the central axial line thereof points in a diametrical direction of the rotor 26.

According to the present embodiment, if the position of the first magnetizing coil 14 is assumed to be at 0°, the second magnetizing coil 16 is arranged at 135°, and the third magnetizing coil 18 is arranged at 225°. Accordingly, as viewed in plan, the first magnetizing coil 14, the second magnetizing coil 16, and the third magnetizing coil 18 are arranged so as to have a Y-shaped positional relationship.

Moreover, according to the present embodiment, the first magnetizing coil 14, the second magnetizing coil 16, and the third magnetizing coil 18 may be arranged predetermined angles apart in the circumferential direction of the magnetizing yoke 12. Accordingly, the first magnetizing coil 14, the second magnetizing coil 16, and the third magnetizing coil 18 may be arranged in any arbitrary positional relationship. Further, the angular positions of the first magnetizing coil 14, the second magnetizing coil 16, and the third magnetizing coil 18 may be appropriately adjusted in accordance with the number of poles (and the arrangement angles) of the magnetic bodies 30 that serve as objects to be magnetized.

The first magnetizing coil 14, the second magnetizing coil 16, and the third magnetizing coil 18 are arranged at angular positions facing toward any one magnetic body 30 from among the plurality of magnetic bodies 30. Specifically, the first magnetizing coil 14 faces toward a magnetic body 30 (the first magnetic body 34) arranged at an angle of 0°. The second magnetizing coil 16 faces toward a magnetic body 30 (a second magnetic body 38) arranged at an angle of 135°. The third magnetizing coil 18 faces toward a magnetic body 30 (a third magnetic body 40) arranged at an angle of 225°.

The control unit 22 supplies an electrical current for the purpose of generating a magnetic field used for magnetization to the first magnetizing coil 14, the second magnetizing coil 16, and the third magnetizing coil 18. Further, the control unit 22 supplies an electrical current for the purpose of generating auxiliary magnetic fields (a first auxiliary magnetic field, a second auxiliary magnetic field) to the first auxiliary coil 19 and the second auxiliary coil 20.

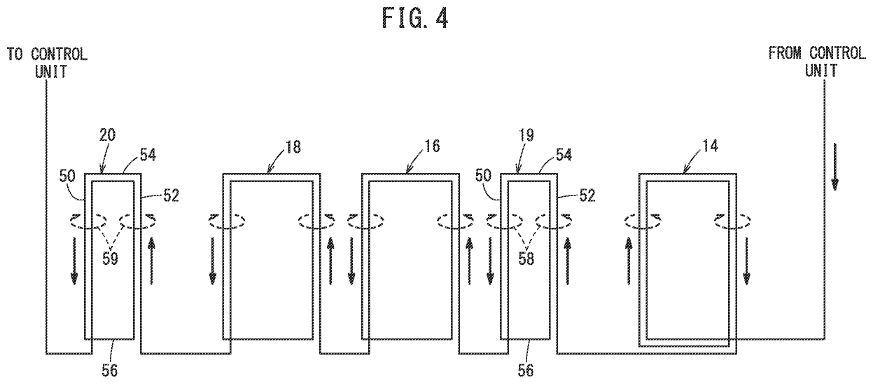

FIG. 4 is an unfolded view in which there are schematically shown connections of the first magnetizing coil 14, the second magnetizing coil 16, the third magnetizing coil 18, the first auxiliary coil 19, and the second auxiliary coil 20 at a time when viewed from the rotor 26 toward an outer side in the diametrical direction. As shown in FIG. 4, the first magnetizing coil 14, the second magnetizing coil 16, the third magnetizing coil 18, the first auxiliary coil 19, and the second auxiliary coil 20 are electrically connected in series with respect to the control unit 22 (refer to FIG. 1 and FIG. 3). More specifically, the first magnetizing coil 14, the first auxiliary coil 19, the second magnetizing coil 16, the third magnetizing coil 18, and the second auxiliary coil 20 are connected in this order with respect to the control unit 22.

Specifically, the first magnetizing coil 14 is wound in a clockwise direction. The second magnetizing coil 16, the third magnetizing coil 18, the first auxiliary coil 19, and the second auxiliary coil 20 are wound in a counterclockwise direction. The winding direction of the first magnetizing coil 14, and the winding directions of the second magnetizing coil 16, the third magnetizing coil 18, the first auxiliary coil 19, and the second auxiliary coil 20 differ from each other.

One end (a starting end) of the first magnetizing coil 14 is electrically connected to the control unit 22 (refer to FIG. 1 and FIG. 3). Another end (a terminal end) of the first magnetizing coil 14 is electrically connected to one end of the first auxiliary coil 19. Another end of the first auxiliary coil 19 is electrically connected to one end of the second magnetizing coil 16. Another end of the second magnetizing coil 16 is electrically connected to one end of the third magnetizing coil 18. Another end of the third magnetizing coil 18 is electrically connected to one end of the second auxiliary coil 20. Another end of the second auxiliary coil 20 is electrically connected to the control unit 22.

Moreover, it should be noted that, in FIG. 1 to FIG. 3, the first magnetizing coil 14, the second magnetizing coil 16, the third magnetizing coil 18, the first auxiliary coil 19, and the second auxiliary coil 20 are schematically illustrated. According to the present embodiment, the number of windings (or turns) of each of the first magnetizing coil 14, the second magnetizing coil 16, the third magnetizing coil 18, the first auxiliary coil 19, and the second auxiliary coil 20 is one or more. In FIG. 4, as one example, a case is shown in which the number of windings of each of the first magnetizing coil 14, the second magnetizing coil 16, the third magnetizing coil 18, the first auxiliary coil 19, and the second auxiliary coil 20 is two.

As shown in FIG. 3, by the electrical current being supplied from the control unit 22, the first magnetizing coil 14, the second magnetizing coil 16, and the third magnetizing coil 18 generate magnetic fields along the diametrical direction of the rotor 26. The generated magnetic fields are applied to the rotor 26.

Specifically, the first magnetizing coil 14 causes a diametrical outwardly directed magnetic field (a first magnetic field 42) to be generated, and applies the generated first magnetic field 42 to the rotor 26. The first magnetic body 34 that faces toward the first magnetizing coil 14 is magnetized in a diametrical outward direction by the first magnetic field 42.

The second magnetizing coil 16 causes a diametrical inwardly directed magnetic field (a second magnetic field 44) to be generated, and applies the generated second magnetic field 44 to the rotor 26. The second magnetic body 38 that faces toward the second magnetizing coil 16 is magnetized in a diametrical inward direction by the second magnetic field 44.

The third magnetizing coil 18 causes a diametrical inwardly directed magnetic field (a third magnetic field 46) to be generated, and applies the generated third magnetic field 46 to the rotor 26. The third magnetic body 40 that faces toward the third magnetizing coil 18 is magnetized in a diametrical inward direction by the third magnetic field 46.

According to the present embodiment, the directions of the first magnetic field 42, the second magnetic field 44, and the third magnetic field 46 are determined by the winding direction (direction of winding) of the first magnetizing coil 14, the second magnetizing coil 16, and the third magnetizing coil 18, respectively. As noted previously, the winding direction of the first magnetizing coil 14, and the winding direction of the second magnetizing coil 16 and the third magnetizing coil 18 are different from each other (refer to FIG. 4). Therefore, the first magnetizing coil 14 causes a diametrical outwardly directed first magnetic field 42 (refer to FIG. 3) to be generated. Further, each of the second magnetizing coil 16 and the third magnetizing coil 18 causes a diametrical inwardly directed magnetic field (the second magnetic field 44, the third magnetic field 46) to be generated.

According to the present embodiment, for example, after magnetization has been carried out at the angular positions shown in FIG. 1 to FIG. 3, the rotor 26 is rotated by a predetermined angle under human power or the like, and the magnetization is repeatedly carried out. Therefore, the plurality of magnetic bodies 30 which are arranged alongside one another in the circumferential direction are magnetized in a manner so that north poles and south poles alternately appear on the outer circumferential side of the rotor 26.

Moreover, according to the present embodiment, the magnetization may be repeatedly carried out by causing the rotor 26 to be rotated by a predetermined angle about a central axial line of the rotor 26 by means of a non-illustrated rotation mechanism.

As shown in FIG. 2 and FIG. 3, each of the first auxiliary coil 19 and the second auxiliary coil 20 is arranged in the magnetizing yoke 12 in a manner so as to face toward the outer circumferential surface 36 of the rotor 26. The first auxiliary coil 19 and the second auxiliary coil 20 are arranged in the magnetizing yoke 12 in a manner so as to sandwich the first magnetizing coil 14 therebetween in the circumferential direction of the magnetizing yoke 12. More specifically, in the magnetizing yoke 12, the first auxiliary coil 19 and the second auxiliary coil 20 are arranged on both sides of the first magnetizing coil 14 along the circumferential direction of the rotor 26. In detail, the first auxiliary coil 19 is arranged between the first magnetizing coil 14 and the second magnetizing coil 16. The second auxiliary coil 20 is arranged between the first magnetizing coil 14 and the third magnetizing coil 18.

The first auxiliary coil 19 and the second auxiliary coil 20 face toward two of the magnetic bodies 30 (a fourth magnetic body 48, a fifth magnetic body 49) that are adjacent to the first magnetic body 34 along the circumferential direction.

Specifically, the first auxiliary coil 19 faces toward the magnetic body 30 (the fourth magnetic body 48) that is arranged at an angle of 45° with respect to the first magnetic body 34. The first auxiliary coil 19 faces toward the fourth magnetic body 48 in a manner so that a central axial line 51 of the first auxiliary coil 19 points in the diametrical direction of the rotor 26.

The second auxiliary coil 20 faces toward the magnetic body 30 (the fifth magnetic body 49) that is arranged at an angle of −45° with respect to the first magnetic body 34. The second auxiliary coil 20 faces toward the fifth magnetic body 49 in a manner so that a central axial line 53 of the second auxiliary coil 20 points in the diametrical direction of the rotor 26.

The first auxiliary coil 19 and the second auxiliary coil 20 are of the same shape and size. Each of the first auxiliary coil 19 and the second auxiliary coil 20 includes a first straight line portion 50, a second straight line portion 52, a first connecting portion 54, and a second connecting portion 56.

Each of the first straight line portion 50 and the second straight line portion 52 extends in the axial direction of the rotor 26. The first connecting portion 54 connects one end of the first straight line portion 50 and one end of the second straight line portion 52. The second connecting portion 56 connects another end of the first straight line portion 50 and another end of the second straight line portion 52. The length of each of the first connecting portion 54 and the second connecting portion 56 along the circumferential direction of the rotor 26 is shorter than the length of each of the first straight line portion 50 and the second straight line portion 52 along the axial direction of the rotor 26. Further, the length of each of the first connecting portion 54 and the second connecting portion 56 along the circumferential direction is shorter than the radius of the rotor 26.

In the first auxiliary coil 19, the first straight line portion 50 and the second straight line portion 52 are arranged at an interval in the circumferential direction, in a manner so as to sandwich the fourth magnetic body 48 therebetween when viewed from the diametrical direction of the rotor 26. Further, in the second auxiliary coil 20, the first straight line portion 50 and the second straight line portion 52 are arranged at an interval in the circumferential direction, in a manner so as to sandwich the fifth magnetic body 49 therebetween when viewed from the diametrical direction of the rotor 26.

The first auxiliary coil 19, because of the supply of the electrical current from the control unit 22, generates the first auxiliary magnetic field. The second auxiliary coil 20, because of the supply of the electrical current from the control unit 22, generates the second auxiliary magnetic field. The first auxiliary magnetic field and the second auxiliary magnetic field are generated in a manner so as to sandwich the first magnetic field 42 therebetween. The first auxiliary magnetic field and the second auxiliary magnetic field are diametrical inwardly directed magnetic fields. According to the present embodiment, the directions of the first auxiliary magnetic field and the second auxiliary magnetic field are determined by the winding method (the winding direction) of each of the first auxiliary coil 19 and the second auxiliary coil 20. As noted previously, the winding direction of the first auxiliary coil 19 and the winding direction of the second auxiliary coil 20 are directions that differ from the winding direction of the first magnetizing coil 14 (refer to FIG. 4). Therefore, each of the first auxiliary coil 19 and the second auxiliary coil 20 causes a diametrical inwardly directed auxiliary magnetic field to be generated.

The intensity of each of the first auxiliary magnetic field and the second auxiliary magnetic field is smaller than the intensity of the first magnetic field 42 to the third magnetic field 46. According to the present embodiment, the intensity of each of the first auxiliary magnetic field and the second auxiliary magnetic field is determined by the number of windings (or turns) of each of the first auxiliary coil 19 and the second auxiliary coil 20. Therefore, as the number of windings of each of the first auxiliary coil 19 and the second auxiliary coil 20 becomes smaller, the intensity of each of the first auxiliary magnetic field and the second auxiliary magnetic field becomes weaker. In other words, according to the present embodiment, by appropriately adjusting the number of windings of each of the first auxiliary coil 19 and the second auxiliary coil 20, the intensity of each of the first auxiliary magnetic field and the second auxiliary magnetic field can be made smaller than the intensity of the first magnetic field 42 to the third magnetic field 46.

The first auxiliary magnetic field and the second auxiliary magnetic field that are generated are applied to the rotor 26. At the fourth magnetic body 48, a diametrical inwardly directed first auxiliary magnetic flux 58 passes therethrough due to the first auxiliary magnetic field. At the fifth magnetic body 49, a diametrical inwardly directed second auxiliary magnetic flux 59 passes therethrough due to the second auxiliary magnetic field.

Moreover, as shown in FIG. 3, the first auxiliary magnetic flux 58 passes in a diametrical outward direction through the magnetic body 30 that is disposed between the fourth magnetic body 48 and the second magnetic body 38. The second auxiliary magnetic flux 59 passes in a diametrical outward direction through the magnetic body 30 that is disposed between the fifth magnetic body 49 and the third magnetic body 40. In other words, when viewed from these magnetic bodies 30, the first auxiliary coil 19 and the second auxiliary coil 20 serve to apply a diametrical outwardly directed magnetic field (the first auxiliary magnetic field, the second auxiliary magnetic field).

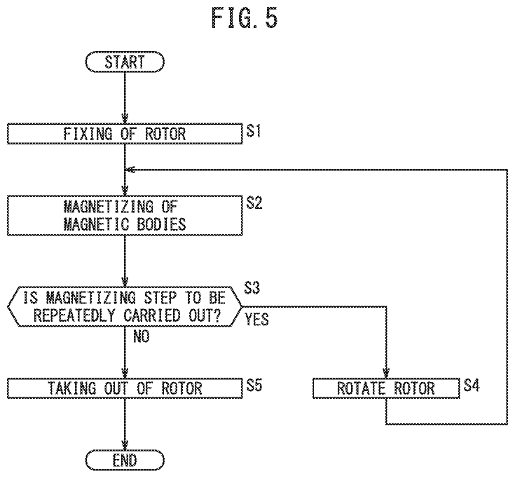

The magnetizing device 10 of the present embodiment is constituted in the manner described above. Next, a description will be given with reference to the flowchart of FIG. 5 concerning a magnetizing method of the present embodiment.

In an arrangement step of step S1 in FIG. 5, the rotor 26 is fixed to the magnetizing device 10 (refer to FIG. 1 and FIG. 3). Specifically, the rotor 26 having the eight individual magnetic bodies 30 is arranged in the hollow part 24. In this case, the rotor 26 is positioned in a circumferential direction with respect to the magnetizing yoke 12, so that among the plurality of magnetic bodies 30, five of the magnetic bodies 30 face toward the first magnetizing coil 14, the second magnetizing coil 16, the third magnetizing coil 18, the first auxiliary coil 19, and the second auxiliary coil 20 in the diametrical direction of the rotor 26. Consequently, the magnetic body 30 that faces in the diametrical direction of the rotor 26 with respect to the first magnetizing coil 14 becomes the first magnetic body 34. The magnetic body 30 that faces in the diametrical direction with respect to the second magnetizing coil 16 becomes the second magnetic body 38. The magnetic body 30 that faces in the diametrical direction with respect to the third magnetizing coil 18 becomes the third magnetic body 40. The magnetic body 30 that faces in the diametrical direction with respect to the first auxiliary coil 19 becomes the fourth magnetic body 48. The magnetic body 30 that faces in the diametrical direction with respect to the second auxiliary coil 20 becomes the fifth magnetic body 49. Stated otherwise, in the arranging step of step S1, the first magnetizing coil 14, the second magnetizing coil 16, the third magnetizing coil 18, the first auxiliary coil 19, and the second auxiliary coil 20 are arranged in a manner so as to face toward the outer circumferential surface 36 of the rotor 26. Thereafter, the rotor 26 is fixed to the magnetizing yoke 12 by a non-illustrated fixing member.

In a subsequent magnetizing step of step S2, a first magnetizing operation is carried out. As shown in FIG. 4, the first magnetizing coil 14, the first auxiliary coil 19, the second magnetizing coil 16, the third magnetizing coil 18, and the second auxiliary coil 20 are connected in series with respect to the control unit 22. Therefore, in the magnetizing step, the control unit 22 supplies an electrical current to the first magnetizing coil 14, the second magnetizing coil 16, the third magnetizing coil 18, the first auxiliary coil 19, and the second auxiliary coil 20.

While the electrical current is supplied from the control unit 22, the first magnetizing coil 14 causes the diametrical outwardly directed first magnetic field 42 to be generated. When the first magnetic field 42 is generated, a diametrical outwardly directed magnetic flux passes through the first magnetic body 34. Consequently, the first magnetic body 34 is magnetized in a diametrical outward direction. More specifically, the first magnetic body 34 is magnetized in a direction in which the diametrically directed outer side thereof becomes the N pole, and the diametrically directed inner side thereof becomes the S pole.

While the electrical current is supplied from the control unit 22, the second magnetizing coil 16 causes the diametrical inwardly directed second magnetic field 44 to be generated. When the second magnetic field 44 is generated, a diametrical inwardly directed magnetic flux passes through the second magnetic body 38. Consequently, the second magnetic body 38 is magnetized in a diametrical inward direction. More specifically, the second magnetic body 38 is magnetized in a direction in which the diametrically directed inner side thereof becomes the N pole, and the diametrically directed outer side thereof becomes the S pole.

While the electrical current is supplied from the control unit 22, the third magnetizing coil 18 causes the diametrical inwardly directed third magnetic field 46 to be generated. When the third magnetic field 46 is generated, a diametrical inwardly directed magnetic flux passes through the third magnetic body 40. Consequently, the third magnetic body 40 is magnetized in a diametrical inward direction. More specifically, the third magnetic body 40 is magnetized in a direction in which the diametrically directed inner side thereof becomes the N pole, and the diametrically directed outer side thereof becomes the S pole.

In the magnetizing step, as shown by the white arrow in FIG. 3, as viewed in plan, a Y-shaped magnetic circuit 60 in the interior of the rotor 26 is formed by the magnetic field (the first magnetic field 42) passing through the first magnetic body 34, the magnetic field (the second magnetic field 44) passing through the second magnetic body 38, and the magnetic field (the third magnetic field 46) passing through the third magnetic body 40. Consequently, with respect to the rotor 26 as well which is relatively small in diameter, the magnetic field used for magnetization reaches to a central side of the first magnetic body 34, the second magnetic body 38, and the third magnetic body 40. As a result, the first magnetic body 34, the second magnetic body 38, and the third magnetic body 40 can be magnetized more effectively.

Further, by means of the first magnetic field 42, the first magnetizing coil 14 draws in a composite magnetic field 62 that is a composite of the second magnetic field 44 and the third magnetic field 46. Consequently, magnetic flux lines are concentrated in the vicinity of the first magnetizing coil 14, whereby the magnetic field intensity greatly increases in the vicinity of the first magnetizing coil 14. Further, the magnetic field intensity in the vicinity of the second magnetizing coil 16 and the third magnetizing coil 18 also increases. As a result, the magnetic susceptibility of the first magnetic body 34, the second magnetic body 38, and the third magnetic body 40 can be increased, and high performance permanent magnets with higher magnetic flux density can be formed.

Furthermore, in the magnetizing step, at a time when the first magnetizing coil 14 draws in the composite magnetic field 62 by the first magnetic field 42, as shown by the dashed lines, the magnetic flux that is not drawn in by the first magnetic field 42 becomes a diametrical outwardly directed leakage magnetic flux 64. Among the plurality of magnetic bodies 30, due to the passage of the leakage magnetic flux 64, there is a possibility that a portion of the magnetic bodies 30 may be magnetized in a direction opposite to the original magnetizing direction.

Specifically, the fourth magnetic body 48 and the fifth magnetic body 49, which are adjacent to each other in the circumferential direction in a manner so as to sandwich the first magnetic body 34 therebetween, are originally magnetized in a diametrical inward direction. However, when the diametrical outwardly directed leakage magnetic flux 64 passes through the fourth magnetic body 48 and the fifth magnetic body 49, there is a possibility that the fourth magnetic body 48 and the fifth magnetic body 49 may be magnetized in a direction (the diametrical outward direction) opposite to the original diametrical inwardly directed magnetizing direction.

Moreover, it should be noted that the leakage magnetic flux 64 also passes through each of the magnetic bodies 30 that are arranged at the angular positions of 90°, 180°, and 270° with respect to the first magnetic body 34. However, the original magnetizing direction of these magnetic bodies 30 is the diametrical outward direction. Therefore, even if the diametrical outwardly directed leakage magnetic flux 64 passes through these magnetic bodies 30, these magnetic bodies will not be magnetized in a direction opposite to the original magnetizing direction (the diametrical outward direction).

Thus, in the magnetizing step, as noted previously, the control unit 22 also supplies an electrical current to the first auxiliary coil 19 and the second auxiliary coil 20. While the electrical current is supplied from the control unit 22, the first auxiliary coil 19 causes a diametrical inwardly directed first auxiliary magnetic field to be generated. While the electrical current is supplied from the control unit 22, the second auxiliary coil 20 causes a diametrical inwardly directed second auxiliary magnetic field to be generated.

More specifically, the winding direction of each of the first auxiliary coil 19 and the second auxiliary coil 20 differs from the winding direction of the first magnetizing coil 14. Therefore, the direction of the electrical current flowing through the first auxiliary coil 19 and the second auxiliary coil 20 is opposite to the direction of the electrical current flowing through the first magnetizing coil 14. Consequently, a diametrical inwardly directed first auxiliary magnetic field is generated around the first auxiliary coil 19. A diametrical inwardly directed second auxiliary magnetic field is generated around the second auxiliary coil 20.

Due to the first auxiliary magnetic field being generated, the diametrical inwardly directed first auxiliary magnetic flux 58 passes through the fourth magnetic body 48 that is adjacent to the first magnetic body 34 along the circumferential direction of the rotor 26. Further, due to the second auxiliary magnetic field being generated, the diametrical inwardly directed second auxiliary magnetic flux 59 passes through the fifth magnetic body 49 that is adjacent to the first magnetic body 34 along the circumferential direction of the rotor 26. As a result, the diametrical outwardly directed leakage magnetic flux 64 passes through the interior of the rotor 26 in a manner so as to avoid the fourth magnetic body 48 and the fifth magnetic body 49. Therefore, it is possible to avoid a situation in which the fourth magnetic body 48 and the fifth magnetic body 49 are magnetized in a direction that is opposite to the original magnetizing direction (the direction of the diametrically directed inner side).

After the first magnetizing operation is completed in the manner described above, in a following step S3, it is determined whether or not the magnetizing step of step S2 is to be repeated.

In the case of repeating the magnetizing step of step S2 (step S3: YES), it is determined to execute the magnetizing step for a second time. In a following step S4, the rotor 26 is rotated by −90° under human power or the like. Consequently, the magnetic body 30, which was placed at an angle of 90° in the magnetizing step for the first time, faces toward the first magnetizing coil 14. More specifically, the three magnetic bodies 30 that were not magnetized in the first magnetization operation are used as a new first magnetic body 34 to a third magnetic body 40, and are made to face in the diametrical direction of the rotor 26 toward the first magnetizing coil 14 to the third magnetizing coil 18.

Thereafter, the process returns to step S2, and a second magnetizing operation is executed in the same manner as the first magnetizing operation. Thereafter, in the same manner, after the second magnetizing operation has been completed, the rotor 26 is rotated by −90°, and a third magnetizing operation is executed. Further, after the third magnetizing operation has been completed, the rotor 26 is rotated by −90°, and a fourth magnetizing operation is executed. In this manner, by performing the magnetizing operation four times, all of the magnetic bodies 30 are magnetized.

After the fourth magnetizing operation is completed, in step S3, it is determined to bring the magnetizing operation to an end (step S3: NO). Thereafter, the magnetizing device 10 proceeds to step S5.

In step S5, the rotor 26 is taken out from the magnetizing device 10.

Moreover, in the above-described magnetizing method, in step S2, the fourth magnetic body 48 may be magnetized in a diametrical inward direction by the first auxiliary magnetic flux 58, and together therewith, the fifth magnetic body 49 may be magnetized in a diametrical inward direction by the second auxiliary magnetic flux 59. In this case, the number of windings of each of the first auxiliary coil 19 and the second auxiliary coil 20 may be increased, and thereby the intensity of the first auxiliary magnetic field and the second auxiliary magnetic field may be made larger. However, as the intensity of the first auxiliary magnetic field and the second auxiliary magnetic field becomes greater, the intensity of the first magnetic field 42 becomes relatively smaller. Accordingly, it is necessary to take the strength of the first magnetic field 42 into consideration, and appropriately adjust the number of windings of each of the first auxiliary coil 19 and the second auxiliary coil 20.

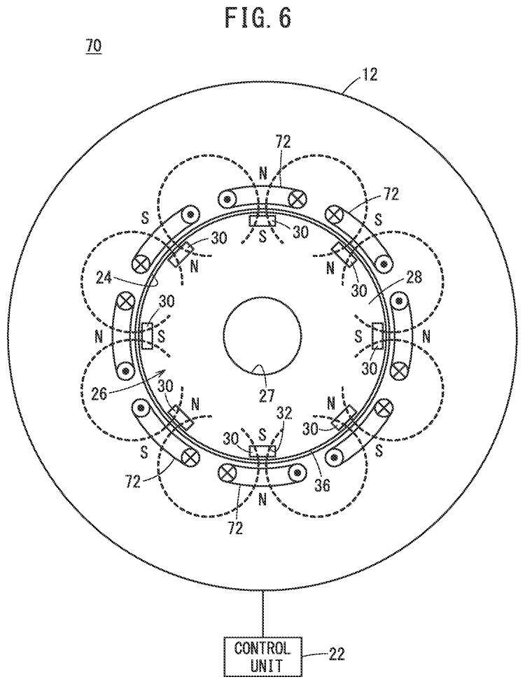

FIG. 6 is a view showing a magnetic field distribution of a magnetizing device 70 according to a first comparative example. Moreover, it should be noted that, in the first comparative example, the same constituent features as those of the present embodiment will be denoted and described with the same reference numerals, and the same treatment will applied hereinafter.

In the first comparative example, a magnetizing device 70 having eight individual magnetizing coils 72 is used. The eight individual magnetizing coils 72 are arranged in facing relation to each of the eight individual magnetic bodies 30. In the case of the magnetizing device 70, an electrical current is supplied simultaneously from the control unit 22 to the eight individual magnetizing coils 72. Stated otherwise, according to the first comparative example, the eight individual magnetic bodies 30 are magnetized simultaneously. However, in the first comparative example, the magnetic circuit is made smaller in comparison with that in the present embodiment (refer to FIG. 3). A sufficient magnetic field cannot be applied inwardly of the magnetic body 30.

In contrast thereto, according to the present embodiment, as shown in FIG. 3, the electrical current is supplied to the first magnetizing coil 14, the second magnetizing coil 16, and the third magnetizing coil 18 that are spaced apart in the circumferential direction. In addition, according to the present embodiment, a large magnetic circuit 60 can be formed. Therefore, it is possible to effectively magnetize the first magnetic body 34 to the third magnetic body 40 to the interior thereof. Further, since the magnetic flux passing through the second magnetic body 38 and the third magnetic body 40 can be concentrated on the first magnetic body 34, a higher magnetic field used for magnetization is capable of being applied to the first magnetic body 34.

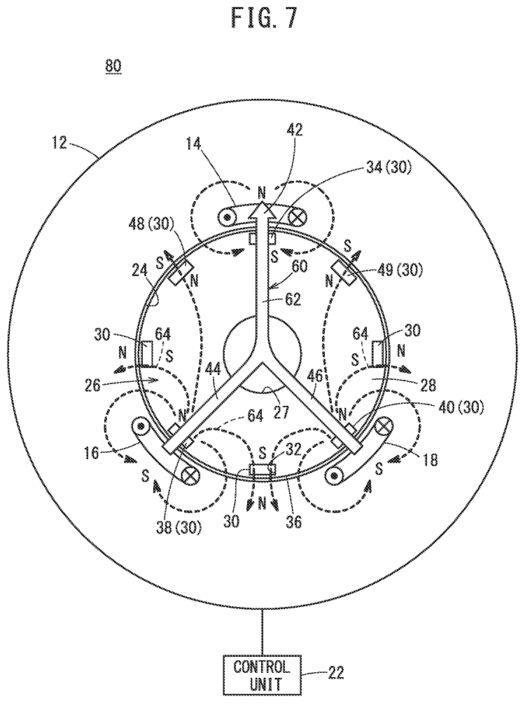

FIG. 7 is a view showing a magnetic field distribution of a magnetizing device 80 according to a second comparative example. The second comparative example differs from the present embodiment (refer to FIG. 3) in that the first auxiliary coil 19 and the second auxiliary coil 20 are not provided. According to the second comparative example, the diametrical outwardly directed leakage magnetic flux 64 that is not drawn into the first magnetic field 42 passes through the fourth magnetic body 48 and the fifth magnetic body 49 that are adjacent to the first magnetic body 34. Consequently, in the second comparative example, the fourth magnetic body 48 and the fifth magnetic body 49 are magnetized in a direction that is opposite to the original magnetizing direction (the diametrical inward direction).

In contrast thereto, in the present embodiment, as shown in FIG. 3, due to the diametrical inwardly directed first auxiliary magnetic field that is generated in the vicinity of the first auxiliary coil 19, the diametrical inwardly directed first auxiliary magnetic flux 58 passes through the fourth magnetic body 48. Further, due to the diametrical inwardly directed second auxiliary magnetic field that is generated in the vicinity of the second auxiliary coil 20, the diametrical inwardly directed second auxiliary magnetic flux 59 passes through the fifth magnetic body 49. Consequently, the diametrical outwardly directed leakage magnetic flux 64 passes through the interior of the rotor 26 in a manner so as to avoid the diametrical inwardly directed first auxiliary magnetic flux 58 and the diametrical inwardly directed second auxiliary magnetic flux 59. As a result, the fourth magnetic body 48 and the fifth magnetic body 49 can be prevented from being magnetized in a direction that is opposite to the original magnetizing direction (the diametrical inward direction).

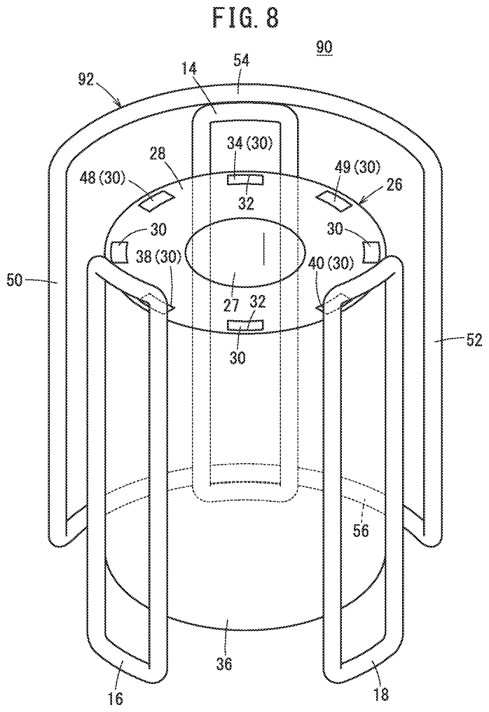

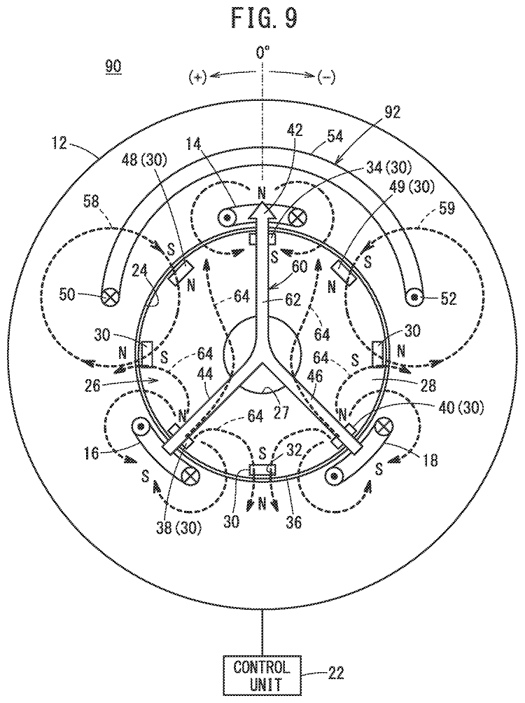

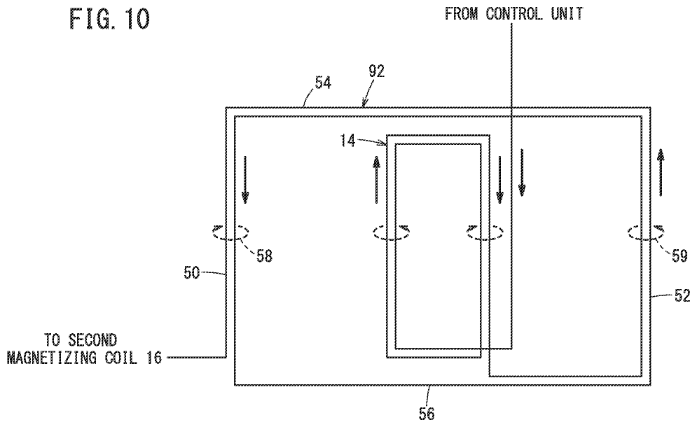

FIG. 8 is a perspective view of a magnetizing device 90 according to a third comparative example. FIG. 9 is a diagram showing a magnetic field distribution of the magnetizing device 90. FIG. 10 is an unfolded view in which there are schematically shown, in the magnetizing device 90, connections of the first magnetizing coil 14 and an auxiliary coil 92 when viewed from the rotor 26 toward an outer side in the diametrical direction. Moreover, it should be noted that, in FIG. 8, illustration of the magnetizing yoke 12 is omitted.

In the magnetizing device 90 of the third comparative example, one auxiliary coil 92 is arranged in the magnetizing yoke 12 in a manner so as to face toward the outer circumferential surface 36 of the rotor 26. The auxiliary coil 92 is arranged in the magnetizing yoke 12 in a manner so as to sandwich the first magnetizing coil 14. Specifically, the auxiliary coil 92 includes the first straight line portion 50, the second straight line portion 52, the first connecting portion 54, and the second connecting portion 56.

The first straight line portion 50 is arranged between the first magnetizing coil 14 and the second magnetizing coil 16. The first straight line portion 50 is disposed in facing relation to a portion between the fourth magnetic body 48 and the magnetic body 30 that is arranged at an angle of 90° From the first magnetic body 34. The second straight line portion 52 is arranged between the first magnetizing coil 14 and the third magnetizing coil 18. The second straight line portion 52 is disposed in facing relation to a portion between the fifth magnetic body 49 and the magnetic body 30 that is arranged at an angle of −90° From the first magnetic body 34.

In the third comparative example, the first magnetizing coil 14, the second magnetizing coil 16, the third magnetizing coil 18, and the auxiliary coil 92 are electrically connected in series with respect to the control unit 22. In this case, the first magnetizing coil 14, the auxiliary coil 92, the second magnetizing coil 16, and the third magnetizing coil 18 are connected in this order with respect to the control unit 22.

In FIG. 10, the first magnetizing coil 14 and the auxiliary coil 92 are illustrated. The first magnetizing coil 14 is wound in a clockwise direction. The auxiliary coil 92 is wound in a counterclockwise direction. The winding direction of the first magnetizing coil 14 and the winding direction of the auxiliary coil 92 differ from each other.

Another end of the first magnetizing coil 14 is electrically connected to one end of the auxiliary coil 92. Another end of the auxiliary coil 92 is electrically connected to one end of the second magnetizing coil 16.

At a time when the electrical current is supplied from the control unit 22, the auxiliary coil 92 generates a first magnetic field and a second magnetic field in a manner so as to sandwich the first magnetic field 42 therebetween. In detail, while the electrical current is supplied from the control unit 22, the first straight line portion 50 causes a diametrical inwardly directed first auxiliary magnetic field to be generated, and together therewith, the second straight line portion 52 causes a diametrical inwardly directed second auxiliary magnetic field to be generated. Accordingly, at the fourth magnetic body 48, a diametrical inwardly directed first auxiliary magnetic flux 58 passes therethrough due to the first auxiliary magnetic field. At the fifth magnetic body 49, a diametrical inwardly directed second auxiliary magnetic flux 59 passes therethrough due to the second auxiliary magnetic field.

Therefore, even in the third comparative example, in the magnetizing operation, even if the diametrical outwardly directed leakage magnetic flux 64 is generated, by the diametrical inwardly directed first auxiliary magnetic flux 58 and the second auxiliary magnetic flux 59 being made to pass through the fourth magnetic body 48 and the fifth magnetic body 49, it is possible to avoid a situation in which the fourth magnetic body 48 and the fifth magnetic body 49 are magnetized in a direction opposite to the original magnetizing direction.

However, in the third comparative example, as noted previously, the auxiliary coil 92 is arranged in the magnetizing yoke 12 in a manner so as to sandwich the first magnetizing coil 14. Therefore, in the auxiliary coil 92, the entire length of the first connecting portion 54 and the second connecting portion 56 becomes longer. Owing to this feature, the entire length of the auxiliary coil 92 becomes longer, and the resistance component of the auxiliary coil 92 becomes greater. As a result, when the electrical current flows through the auxiliary coil 92, the loss of the auxiliary coil 92 becomes greater.

In contrast thereto, according to the present embodiment, as shown in FIG. 3, the first auxiliary coil 19 and the fourth magnetic body 48 face toward each other in a manner so that a central axial line 51 of the first auxiliary coil 19 points in the diametrical direction of the rotor 26. Further, the second auxiliary coil 20 and the fifth magnetic body 49 face toward each other in a manner so that a central axial line 53 of the second auxiliary coil 20 points in the diametrical direction of the rotor 26. Therefore, in each of the first auxiliary coil 19 and the second auxiliary coil 20, the entire length of the first connecting portion 54 and the second connecting portion 56 is shorter in comparison with that of the auxiliary coil 92. Consequently, according to the present embodiment, the entire length of each of the first auxiliary coil 19 and the second auxiliary coil 20 can be made shorter in comparison with that of the auxiliary coil 92 (refer to FIG. 8 to FIG. 10). As a result, the resistance component of the first auxiliary coil 19 and the second auxiliary coil 20 becomes smaller, and any loss that occurs at a time when the electrical current flows through the first auxiliary coil 19 and the second auxiliary coil 20 can be made smaller.

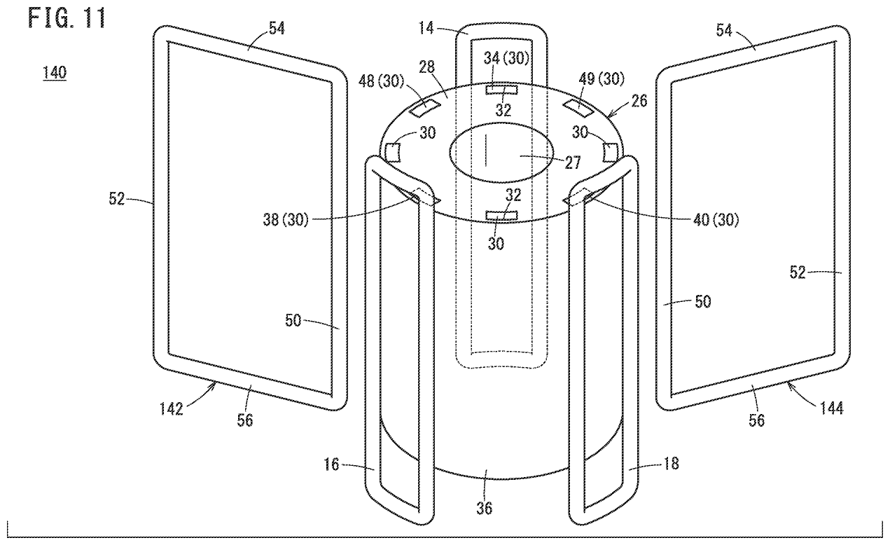

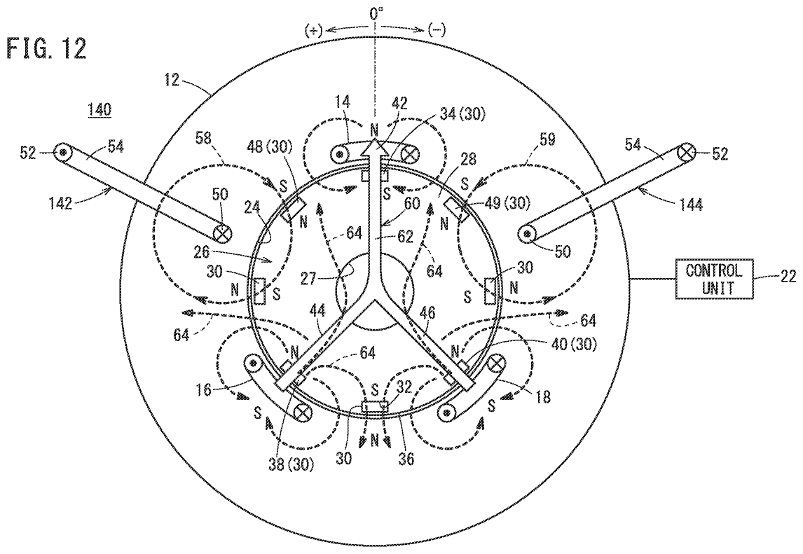

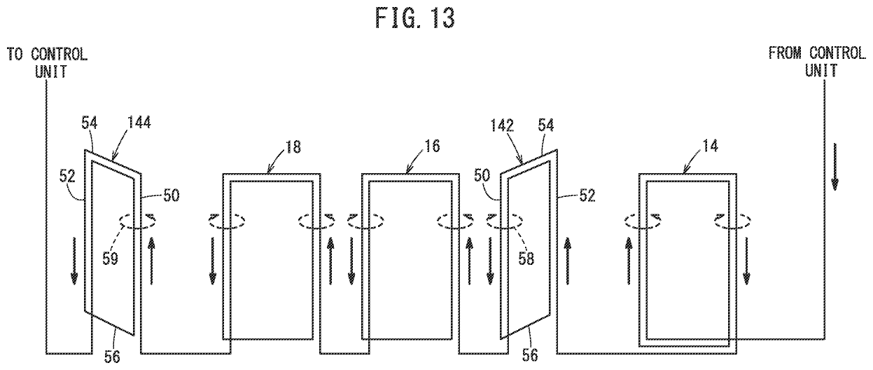

FIG. 11 is a perspective view of a magnetizing device 140 according to an exemplary modification of the present embodiment. FIG. 12 is a diagram showing a magnetic field distribution of the magnetizing device 140. FIG. 13 is an unfolded view in which there are schematically shown, in the magnetizing device 140, connections of the first magnetizing coil 14, the second magnetizing coil 16, the third magnetizing coil 18, a first auxiliary coil 142, and a second auxiliary coil 144 when viewed from the rotor 26 toward an outer side in the diametrical direction. Moreover, it should be noted that, in FIG. 11, illustration of the magnetizing yoke 12 (refer to FIG. 1) is also omitted.

In the present exemplary modification, the magnetizing device 140 includes the first auxiliary coil 142 and the second auxiliary coil 144. Specifically, the first auxiliary coil 142 is arranged between the first magnetizing coil 14 and the second magnetizing coil 16. The second auxiliary coil 144 is arranged between the first magnetizing coil 14 and the third magnetizing coil 18. Each of the first auxiliary coil 142 and the second auxiliary coil 144 is arranged in a manner so that a central axial line thereof points in a tangential direction of the outer circumferential surface 36 of the rotor 26. The first auxiliary coil 142 and the second auxiliary coil 144 extend in the diametrical direction of the rotor 26.

Specifically, in each of the first auxiliary coil 142 and the second auxiliary coil 144, the first straight line portion 50 faces toward the outer circumferential surface 36 of the rotor 26. The second straight line portion 52 is disposed on the diametrically directed outer side of the rotor 26 at an interval from the first straight line portion 50. The first connecting portion 54 and the second connecting portion 56 extend along the diametrical direction of the rotor 26. The length of each of the first connecting portion 54 and the second connecting portion 56 along the diametrical direction of the rotor 26 is shorter than the entire length of each of the first straight line portion 50 and the second straight line portion 52 along the axial direction of the rotor 26.

As shown in FIG. 13, the first magnetizing coil 14, the second magnetizing coil 16, the third magnetizing coil 18, the first auxiliary coil 142, and the second auxiliary coil 144 are electrically connected in series with respect to the control unit 22 (refer to FIG. 12). More specifically, the first magnetizing coil 14, the first auxiliary coil 142, the second magnetizing coil 16, the third magnetizing coil 18, and the second auxiliary coil 144 are connected in this order with respect to the control unit 22.

Specifically, the first magnetizing coil 14 is wound in a clockwise direction. The second magnetizing coil 16, the third magnetizing coil 18, the first auxiliary coil 142, and the second auxiliary coil 144 are wound in a counterclockwise direction. The winding direction of the first magnetizing coil 14, and the winding directions of the second magnetizing coil 16, the third magnetizing coil 18, the first auxiliary coil 142, and the second auxiliary coil 144 differ from each other.

One end of the first magnetizing coil 14 is electrically connected to the control unit 22. Another end of the first magnetizing coil 14 is electrically connected to one end of the first auxiliary coil 142. Another end of the first auxiliary coil 142 is electrically connected to one end of the second magnetizing coil 16. Another end of the second magnetizing coil 16 is electrically connected to one end of the third magnetizing coil 18. Another end of the third magnetizing coil 18 is electrically connected to one end of the second auxiliary coil 144. Another end of the second auxiliary coil 144 is electrically connected to the control unit 22.

While the electrical current is supplied from the control unit 22, the first straight line portion 50 of the first auxiliary coil 142 causes the first auxiliary magnetic field to be generated. The first auxiliary magnetic field is a diametrical inwardly directed magnetic field. Due to the first auxiliary magnetic field being generated, at the fourth magnetic body 48, a diametrical inwardly directed first auxiliary magnetic flux 58 due to the first auxiliary magnetic field passes therethrough. Consequently, the diametrical outwardly directed leakage magnetic flux 64 passes through the interior of the rotor 26 in a manner so as to avoid the diametrical inwardly directed first auxiliary magnetic flux 58, and the fourth magnetic body 48 is prevented from being magnetized in a direction opposite to the original magnetizing direction (the diametrical inward direction).

While the electrical current is supplied from the control unit 22, the first straight line portion 50 of the second auxiliary coil 144 causes the second auxiliary magnetic field to be generated. The second auxiliary magnetic field is a diametrical inwardly directed magnetic field. Due to the second auxiliary magnetic field being generated, at the fifth magnetic body 49, the diametrical inwardly directed second auxiliary magnetic flux 59 due to the second auxiliary magnetic field passes therethrough. Consequently, since the diametrical outwardly directed leakage magnetic flux 64 passes through the rotor 26 in a manner so as to avoid the diametrical inwardly directed second auxiliary magnetic flux 59, the fifth magnetic body 49 is prevented from being magnetized in a direction opposite to the original magnetizing direction (the diametrical inward direction).

Moreover, as shown in FIG. 12, the first auxiliary magnetic flux 58 and the second auxiliary magnetic flux 59 are magnetic fluxes that circulate about the first straight line portion 50. Therefore, the first auxiliary magnetic flux 58 passes in a diametrical outward direction through the magnetic body 30 that is disposed between the fourth magnetic body 48 and the second magnetic body 38. The second auxiliary magnetic flux 59 passes in a diametrical outward direction through the magnetic body 30 that is disposed between the fifth magnetic body 49 and the third magnetic body 40. In other words, when viewed from these magnetic bodies 30, the first auxiliary coil 142 and the second auxiliary coil 144 serve to apply a diametrical outwardly directed magnetic field (the first auxiliary magnetic field, the second auxiliary magnetic field).

In the magnetizing device 140 according to the exemplary modification, as compared with the magnetizing device 10 according to the present embodiment, in each of the first auxiliary coil 142 and the second auxiliary coil 144, the interval between the first straight line portion 50 and the second straight line portion 52 is large. More specifically, the entire length of the first connecting portion 54 and the second connecting portion 56 becomes longer. Therefore, the entire length of each of the first auxiliary coil 142 and the second auxiliary coil 144 becomes longer, and the resistance component thereof becomes greater. As a result, any loss that occurs at a time when the electrical current flows through each of the first auxiliary coil 142 and the second auxiliary coil 144 becomes greater.

However, in the case that the diameter of the rotor 26 is small, and the interval between the plurality of magnetic bodies 30 is narrow, it becomes difficult for the first auxiliary coil 19 and the second auxiliary coil 20 to be arranged in the circumferential direction as in the magnetizing device 10. In contrast to this feature, in the magnetizing device 140 according to the exemplary modification, each of the first auxiliary coil 142 and the second auxiliary coil 144 is arranged in a manner so that a central axial line thereof points in the tangential direction of the outer circumferential surface 36 of the rotor 26. Consequently, even in the case that the diameter of the rotor 26 is small, and the distance between the plurality of magnetic bodies 30 is narrow, it is possible to easily carry out the magnetizing operation with respect to the plurality of magnetic bodies 30.

The present embodiment and the exemplary modification include the following advantageous effects.

As shown in FIG. 3 and FIG. 12, since the composite magnetic field 62 in which the second magnetic field 44 and the third magnetic field 46 are combined is drawn in by the first magnetic field 42, a high intensity magnetic field reaches the interior of the first magnetic body 34 to the third magnetic body 40 of the rotor 26. Consequently, at a low cost, it is possible to magnetize the interior of the first magnetic body 34 to the third magnetic body 40.

Further, at a time when the first magnetic field 42 draws in the composite magnetic field 62 which is a composite of the second magnetic field 44 and the third magnetic field 46, the magnetic flux that is not drawn in by the first magnetic field 42 becomes the diametrical outwardly directed leakage magnetic flux 64. The fourth magnetic body 48 and the fifth magnetic body 49 are adjacent to both sides of the first magnetic body 34 along the circumferential direction of the rotor 26. Therefore, when the leakage magnetic flux 64 passes through the fourth magnetic body 48 and the fifth magnetic body 49, there is a possibility that the fourth magnetic body 48 and the fifth magnetic body 49 may be magnetized in a direction opposite to the original magnetizing direction (the diametrical inward direction).

Thus, according to the present embodiment and the exemplary modification, among the plurality of magnetic bodies 30, a diametrical inwardly directed magnetic flux (the first auxiliary magnetic flux 58, the second auxiliary magnetic flux 59) caused by the first auxiliary magnetic field or the second auxiliary magnetic field is allowed to pass with respect to the fourth magnetic body 48 and the fifth magnetic body 49 that are capable of being magnetized in a direction opposite to the original magnetizing direction. Consequently, the leakage magnetic flux 64 passes through the interior of the rotor 26 in a manner so as to avoid the diametrical inwardly directed first auxiliary magnetic flux 58 and the diametrical inwardly directed second auxiliary magnetic flux 59 that pass through the fourth magnetic body 48 and the fifth magnetic body 49. As a result, it is possible to avoid a situation in which the fourth magnetic body 48 and the fifth magnetic body 49 are magnetized in a direction opposite to the original magnetizing direction. Further, by the leakage magnetic flux 64 avoiding the fourth magnetic body 48 and the fifth magnetic body 49, the leakage magnetic flux 64 becomes capable of being drawn into the first magnetic field 42.

Therefore, in the present embodiment and the exemplary modification, while causing the first magnetic body 34 to the third magnetic body 40 in the interior of the rotor 26 to be magnetized, it is possible to suppress a situation in which the fourth magnetic body 48 and the fifth magnetic body 49 are magnetized in a direction opposite to the original magnetizing direction due to the leakage magnetic flux 64.

As shown in FIG. 3, FIG. 4, FIG. 12, and FIG. 13, in the present embodiment and the exemplary modification, since the electrical current flowing in a direction opposite to the electrical current flowing in the first magnetizing coil 14 flows through the first auxiliary coil 19, 142 and the second auxiliary coil 20, 144, the diametrical inwardly directed first auxiliary magnetic field and the diametrical inwardly directed second auxiliary magnetic field can be easily generated. Consequently, a situation can be efficiently avoided in which the leakage magnetic flux 64 that is not drawn in by the first magnetic field 42 passes through the fourth magnetic body 48 and the fifth magnetic body 49.

As shown in FIG. 2 and FIG. 3, according to the present embodiment, the first auxiliary coil 19 and the fourth magnetic body 48 face toward each other in a manner so that the axial line of the first auxiliary coil 19 points in the diametrical direction of the rotor 26. Further, the second auxiliary coil 20 and the fifth magnetic body 49 face toward each other in a manner so that the axial line of the second auxiliary coil 20 points in the diametrical direction. Consequently, the auxiliary magnetic flux (the first auxiliary magnetic flux 58, the second auxiliary magnetic flux 59) on the diametrically directed inner side can be reliably made to pass through the fourth magnetic body 48 and the fifth magnetic body 49. As a result, the leakage magnetic flux 64 can be reliably prevented from passing through the fourth magnetic body 48 and the fifth magnetic body 49. Further, it is also possible to cause the fourth magnetic body 48 and the fifth magnetic body 49 to be magnetized in the diametrical inward direction.

In addition, by the first auxiliary coil 19 and the fourth magnetic body 48 facing toward each other in a manner so that the axial line of the first auxiliary coil 19 points toward the diametrical direction of the rotor 26, together with the second auxiliary coil 20 and the fifth magnetic body 49 facing toward each other in a manner so that the axial line of the second auxiliary coil 20 points toward the diametrical direction, it becomes possible for the entire length of the first auxiliary coil 19 and the second auxiliary coil 20 to be made shorter. As a result, the resistance component of the first auxiliary coil 19 and the second auxiliary coil 20 becomes smaller, and any loss that occurs at a time when the electrical current flows through the first auxiliary coil 19 and the second auxiliary coil 20 can be made smaller.

As shown in FIG. 2 and FIG. 3, according to the present embodiment, the length of the first connecting portion 54 and the length of the second connecting portion 56 along the circumferential direction of the rotor 26 are shorter than the length of the first straight line portion 50 and the length of the second straight line portion 52 along the axial direction of the rotor 26. Consequently, the entire length of the first auxiliary coil 19 and the second auxiliary coil 20 can be further shortened.

As shown in FIG. 2 and FIG. 3, according to the present embodiment, the length of each of the first connecting portion 54 and the second connecting portion 56 is shorter than the radius of the rotor 26. Consequently, the entire length of the first auxiliary coil 19 and the second auxiliary coil 20 can be further shortened.

As shown in FIG. 11 and FIG. 12, in the exemplary modification, the first auxiliary coil 142 and the fourth magnetic body 48 face toward each other in a manner so that the axial line of the first auxiliary coil 142 points in the tangential direction of the outer circumferential surface 36 of the rotor 26. Further, the second auxiliary coil 144 and the fifth magnetic body 49 face toward each other in a manner so that the axial line of the second auxiliary coil 144 points in the tangential direction of the outer circumferential surface 36 of the rotor 26. Consequently, even in the case that the diameter of the rotor 26 is small, and the distance between the plurality of magnetic bodies 30 is narrow, it is possible to easily carry out the magnetizing operation with respect to the plurality of magnetic bodies 30.

According to the present exemplary modification, the length of the first connecting portion 54 and the length of the second connecting portion 56 along the diametrical direction of the rotor 26 are shorter than the length of the first straight line portion 50 and the length of the second straight line portion 52 along the axial direction of the rotor 26. Consequently, the entire length of the first auxiliary coil 142 and the second auxiliary coil 144 can be made shorter.

In the present embodiment shown in FIGS. 1 to 4 and the exemplary modification shown in FIGS. 11 to 13, the magnitude of the first auxiliary magnetic field and the second auxiliary magnetic field is smaller than the magnitude of the first magnetic field 42, the second magnetic field 44, and the third magnetic field 46. Consequently, without disturbing the magnetizing operation with respect to the first magnetic body 34 to the third magnetic body 40, it is possible to suppress a situation in which the fourth magnetic body 48 and the fifth magnetic body 49 are magnetized in a direction opposite to the original magnetizing direction due to the leakage magnetic flux 64 that is not drawn in by the first magnetic field 42.

As shown in FIG. 4 and FIG. 13, according to the present embodiment and the exemplary modification, the first magnetizing coil 14, the second magnetizing coil 16, the third magnetizing coil 18, and the first auxiliary coil 19 or 142, and the second auxiliary coil 20 or 144 are electrically connected in series with respect to the control unit 22. In accordance with this feature, an electrical current is capable of being simultaneously supplied from the control unit 22 with respect to the first magnetizing coil 14, the second magnetizing coil 16, the third magnetizing coil 18, the first auxiliary coil 19 or 142, and the second auxiliary coil 20 or 144. Consequently, the magnetizing operation can be carried out efficiently.

In relation to the above-described disclosure, the following supplementary notes are further disclosed.

### Supplementary Note 1

In the magnetizing device (10, 140) that magnetizes the plurality of magnetic bodies, by applying, with respect to the rotor (26) having the plurality of magnetic bodies (30) arranged in the circumferential direction, the magnetic field (42, 44, 46) in the diametrical direction of the rotor, the magnetizing device comprises the first magnetizing coil (14) arranged in facing relation to the outer circumferential surface (36) of the rotor, and that causes the diametrical outwardly directed first magnetic field (42) to be generated, the second magnetizing coil (16) arranged in facing relation to the outer circumferential surface of the rotor, and that causes the diametrical inwardly directed second magnetic field (44) to be generated, the third magnetizing coil (18) arranged in facing relation to the outer circumferential surface of the rotor, and that causes the diametrical inwardly directed third magnetic field (46) to be generated, the first auxiliary coil (19, 142) arranged between the first magnetizing coil and the second magnetizing coil in facing relation to the outer circumferential surface of the rotor, and that causes the diametrical inwardly directed first auxiliary magnetic field to be generated, and the second auxiliary coil (20, 144) arranged between the first magnetizing coil and the third magnetizing coil in facing relation to the outer circumferential surface of the rotor, and that causes the diametrical inwardly directed second auxiliary magnetic field to be generated, wherein, by the first magnetizing coil drawing in with the first magnetic field the composite magnetic field (62) which is a composite of the second magnetic field and the third magnetic field, among the plurality of magnetic bodies, the first magnetic body (34) facing toward the first magnetizing coil is magnetized in the diametrical outward direction, the second magnetic body (38) facing toward the second magnetizing coil is magnetized in the diametrical inward direction, and the third magnetic body (40) facing toward the third magnetizing coil is magnetized in the diametrical inward direction, among the magnetic fluxes caused by the second magnetic field and the third magnetic field, the magnetic flux that is not drawn in by the first magnetic field is the diametrical outwardly directed leakage magnetic flux (64), on both sides of the first magnetic body along the circumferential direction, the fourth magnetic body (48) and the fifth magnetic body (49) are adjacent to the first magnetic body while sandwiching the first magnetic body therebetween, with respect to the fourth magnetizing body, the first auxiliary coil allows passage of the diametrical inwardly directed magnetic flux (58) caused by the first auxiliary magnetic field, and with respect to the fifth magnetizing body, the second auxiliary coil allows passage of the diametrical inwardly directed magnetic flux (59) caused by the second auxiliary magnetic field.

According to the present invention, since the composite magnetic field in which the second magnetic field and the third magnetic field are combined is drawn in by the first magnetic field, a high intensity magnetic field reaches the interior of the first magnetic body to the third magnetic body of the rotor. Consequently, at a low cost, it is possible to magnetize the interior of the first magnetic body to the third magnetic body.

Further, at a time when the first magnetic field draws in the composite magnetic field which is a composite of the second magnetic field and the third magnetic field, the magnetic flux that is not drawn in by the first magnetic field becomes the diametrical outwardly directed leakage magnetic flux. The fourth magnetic body and the fifth magnetic body are adjacent to both sides of the first magnetic body along the circumferential direction. Therefore, when the leakage magnetic flux passes through the fourth magnetic body and the fifth magnetic body, there is a possibility that the fourth magnetic body and the fifth magnetic body may be magnetized in a direction opposite to the original magnetizing direction (the diametrical inward direction).

Thus, according to the present invention, among the plurality of magnetic bodies, the diametrical inwardly directed magnetic flux caused by the first auxiliary magnetic field or the second auxiliary magnetic field is allowed to pass with respect to the fourth magnetic body and the fifth magnetic body which are capable of being magnetized in a direction opposite to the original magnetizing direction. Consequently, the leakage magnetic flux passes through the interior of the rotor in a manner so as to avoid the diametrical inwardly directed magnetic flux that passes through the fourth magnetic body and the fifth magnetic body. As a result, it is possible to avoid a situation in which the fourth magnetic body and the fifth magnetic body are magnetized in a direction opposite to the original magnetizing direction. Further, by avoiding the fourth magnetic body and the fifth magnetic body, the leakage magnetic flux becomes capable of being drawn into the first magnetic field.

Therefore, according to the present invention, while causing the first magnetic body to the third magnetic body in the interior of the rotor to be magnetized, it is possible to suppress a situation in which the fourth magnetic body and the fifth magnetic body are magnetized in a direction opposite to the original magnetizing direction due to the leakage magnetic flux.

### Supplementary Note 2

In the magnetizing device according to supplementary note 1, the electrical current may flow respectively in the first auxiliary coil and the second auxiliary coil in a direction opposite to that of the electrical current flowing in the first magnetizing coil.

Since the electrical current flowing in a direction opposite to the electrical current flowing in the first magnetizing coil flows through the first auxiliary coil and the second auxiliary coil, the diametrical inwardly directed first auxiliary magnetic field and the diametrical inwardly directed second auxiliary magnetic field can be easily generated. Consequently, a situation can be efficiently avoided in which the leakage magnetic flux that is not drawn in by the first magnetic field passes through the fourth magnetic body and the fifth magnetic body.

### Supplementary Note 3

In the magnetizing device according to supplementary notes 1 or 2, the first auxiliary coil may face toward the fourth magnetic body in a manner so that an axial line of the first auxiliary coil points in the diametrical direction, and the second auxiliary coil may face toward the fifth magnetic body in a manner so that an axial line of the second auxiliary coil points in the diametrical direction.

The first auxiliary coil and the fourth magnetic body face toward each other in a manner so that the axial line of the first auxiliary coil points in the diametrical direction, and the second auxiliary coil and the fifth magnetic body face toward each other in a manner so that the axial line of the second auxiliary coil points in the diametrical direction. In accordance with such features, the magnetic flux on the diametrically directed inner side can be reliably made to pass through the fourth magnetic body and the fifth magnetic body. As a result, the leakage magnetic flux can be reliably prevented from passing through the fourth magnetic body and the fifth magnetic body. Further, it is also possible to cause the fourth magnetic body and the fifth magnetic body to be magnetized in the diametrical inward direction.

In addition, by the first auxiliary coil and the fourth magnetic body facing toward each other in a manner so that the axial line of the first auxiliary coil points toward the diametrical direction, together with the second auxiliary coil and the fifth magnetic body facing toward each other in a manner so that the axial line of the second auxiliary coil points toward the diametrical direction, it becomes possible for the entire length of the first auxiliary coil and the second auxiliary coil to be made shorter. As a result, the resistance component of the first auxiliary coil and the second auxiliary coil becomes smaller, and any loss that occurs at a time when the electrical current flows through the first auxiliary coil and the second auxiliary coil can be made smaller.

### Supplementary Note 4

In the magnetizing device according to supplementary note 3, the plurality of magnetic bodies may each extend respectively in the axial direction of the rotor, and each of the first auxiliary coil and the second auxiliary coil may include the first straight line portion (50) extending in the axial direction, the second straight line portion (52) arranged to be spaced apart in the circumferential direction with respect to the first straight line portion, and which extends in the axial direction, the first connecting portion (54) extending in the circumferential direction, and connecting one end of the first straight line portion and one end of the second straight line portion, and the second connecting portion (56) extending in the circumferential direction, and connecting another end of the first straight line portion and another end of the second straight line portion, wherein the length of the first connecting portion and the length of the second connecting portion along the circumferential direction may be shorter than the length of the first straight line portion and the length of the second straight line portion along the axial direction.

Since the length of the first connecting portion and the length of the second connecting portion along the circumferential direction are shorter than the length of the first straight line portion and the length of the second straight line portion along the axial direction, the entire length of the first auxiliary coil and the second auxiliary coil can be further shortened.

### Supplementary Note 5

In the magnetizing device according to supplementary note 4, the length of each of the first connecting portion and the second connecting portion may be shorter than the radius of the rotor.

Since the length of each of the first connecting portion and the second connecting portion is shorter than the radius of the rotor, the entire length of the first auxiliary coil and the second auxiliary coil can be further shortened.

### Supplementary Note 6

In the magnetizing device according to supplementary note 1 or 2, the first auxiliary coil may face toward the fourth magnetic body in a manner so that the axial line of the first auxiliary coil points in the tangential direction of the outer circumferential surface of the rotor, and the second auxiliary coil may face toward the fifth magnetic body in a manner so that the axial line of the second auxiliary coil points in the tangential direction of the outer circumferential surface of the rotor.

The first auxiliary coil and the fourth magnetic body face toward each other in a manner so that the axial line of the first auxiliary coil points in the tangential direction of the outer circumferential surface of the rotor, together with the second auxiliary coil and the fifth auxiliary coil facing toward each other in a manner so that the axial line of the second auxiliary coil points in the tangential direction of the outer circumferential surface of the rotor. Consequently, even in the case that the diameter of the rotor is small, and the distance between the plurality of magnetic bodies is narrow, it is possible to easily carry out the magnetizing operation with respect to the plurality of magnetic bodies.

### Supplementary Note 7

In the magnetizing device according to supplementary note 6, the plurality of magnetic bodies may each extend respectively in the axial direction of the rotor, and each of the first auxiliary coil and the second auxiliary coil may include the first straight line portion extending in the axial direction, the second straight line portion arranged to be spaced apart in the diametrical direction with respect to the first straight line portion, and which extends in the axial direction, the first connecting portion extending in the diametrical direction, and connecting one end of the first straight line portion and one end of the second straight line portion, and the second connecting portion extending in the diametrical direction, and connecting another end of the first straight line portion and another end of the second straight line portion, wherein the length of the first connecting portion and the length of the second connecting portion along the diametrical direction may be shorter than the length of the first straight line portion and the length of the second straight line portion along the axial direction.

Since the length of the first connecting portion and the length of the second connecting portion along the diametrical direction are shorter than the length of the first straight line portion and the length of the second straight line portion along the axial direction, the entire length of the first auxiliary coil and the second auxiliary coil can be made shorter.

### Supplementary Note 8

In the magnetizing device according to any one of supplementary notes 1 to 7, the magnitude of the first auxiliary magnetic field and the second auxiliary magnetic field may be smaller than the magnitude of the first magnetic field, the second magnetic field, and the third magnetic field.

By having the magnitude of the first auxiliary magnetic field and the second auxiliary magnetic field be smaller than the magnitude of the first magnetic field, the second magnetic field, and the third magnetic field, without disturbing the magnetizing operation with respect to the first magnetic body to the third magnetic body, it is possible to suppress a situation in which the fourth magnetic body and the fifth magnetic body are magnetized in a direction opposite to the original magnetizing direction due to the leakage magnetic flux that is not drawn in by the first magnetic field.

### Supplementary Note 9

In the magnetizing device according to any one of supplementary notes 1 to 8, there may further be provided the control unit (22) that supplies the electrical current to the first magnetizing coil, the second magnetizing coil, the third magnetizing coil, the first auxiliary coil, and the second auxiliary coil, wherein the first magnetizing coil, the second magnetizing coil, the third magnetizing coil, the first auxiliary coil, and the second auxiliary coil may be electrically connected in series with respect to the control unit.

Since the first magnetizing coil, the second magnetizing coil, the third magnetizing coil, the first auxiliary coil, and the second auxiliary coil are electrically connected in series with respect to the control unit, it becomes possible to simultaneously supply the electrical current from the control unit with respect to the first magnetizing coil, the second magnetizing coil, the third magnetizing coil, the first auxiliary coil, and the second auxiliary coil. Consequently, the magnetizing operation can be carried out efficiently.

### Supplementary Note 10

In the magnetizing method of magnetizing the plurality of magnetic bodies, by applying, with respect to the rotor having the plurality of magnetic bodies arranged in the circumferential direction, the magnetic field in the diametrical direction of the rotor, the magnetizing method comprises the arrangement step (step S1) of arranging the first magnetizing coil, the second magnetizing coil, the third magnetizing coil, the first auxiliary coil, and the second auxiliary coil in facing relation to the outer circumferential surface of the rotor, and the magnetizing step (step S2) in which, by the first magnetizing coil causing the diametrical outwardly directed first magnetic field to be generated, the second magnetizing coil causing the diametrical inwardly directed second magnetic field to be generated, the third magnetizing coil causing the diametrical inwardly directed third magnetic field to be generated, and by the first magnetizing coil drawing in with the first magnetic field the composite magnetic field which is a composite of the second magnetic field and the third magnetic field, among the plurality of magnetic bodies, the first magnetic body facing toward the first magnetizing coil is magnetized in the diametrical outward direction, the second magnetic body facing toward the second magnetizing coil is magnetized in the diametrical inward direction, and the third magnetic body facing toward the third magnetizing coil is magnetized in the diametrical inward direction, in the arrangement step, on both sides of the first magnetic body along the circumferential direction, the fourth magnetic body and the fifth magnetic body are placed adjacent to the first magnetic body while sandwiching the first magnetic body therebetween, among the magnetic fluxes caused by the second magnetic field and the third magnetic field, the magnetic flux that is not drawn in by the first magnetic field is the diametrical outwardly directed leakage magnetic flux, with respect to the fourth magnetizing body, the first auxiliary coil allows passage of the diametrical inwardly directed magnetic flux caused by the first auxiliary magnetic field, and with respect to the fifth magnetizing body, the second auxiliary coil allows passage of the diametrical inwardly directed magnetic flux caused by the second auxiliary magnetic field.

According to the present invention, since the composite magnetic field in which the second magnetic field and the third magnetic field are combined is drawn in by the first magnetic field, a high intensity magnetic field reaches the interior of the first magnetic body to the third magnetic body of the rotor. Consequently, at a low cost, it is possible to magnetize the interior of the first magnetic body to the third magnetic body.

Further, at a time when the first magnetic field draws in the composite magnetic field which is a composite of the second magnetic field and the third magnetic field, the magnetic flux that is not drawn in by the first magnetic field becomes the diametrical outwardly directed leakage magnetic flux. The fourth magnetic body and the fifth magnetic body are adjacent to both sides of the first magnetic body along the circumferential direction. Therefore, when the leakage magnetic flux passes through the fourth magnetic body and the fifth magnetic body, there is a possibility that the fourth magnetic body and the fifth magnetic body may be magnetized in a direction opposite to the original magnetizing direction (the diametrical inward direction).

Thus, according to the present invention, among the plurality of magnetic bodies, the diametrical inwardly directed magnetic flux caused by the first auxiliary magnetic field or the second auxiliary magnetic field is allowed to pass with respect to the fourth magnetic body and the fifth magnetic body which are capable of being magnetized in a direction opposite to the original magnetizing direction. Consequently, the leakage magnetic flux passes through the interior of the rotor in a manner so as to avoid the diametrical inwardly directed magnetic flux that passes through the fourth magnetic body and the fifth magnetic body. As a result, it is possible to avoid a situation in which the fourth magnetic body and the fifth magnetic body are magnetized in a direction opposite to the original magnetizing direction. Further, by avoiding the fourth magnetic body and the fifth magnetic body, the leakage magnetic flux becomes capable of being drawn into the first magnetic field.

Therefore, according to the present invention, while causing the first magnetic body to the third magnetic body in the interior of the rotor to be magnetized, it is possible to suppress a situation in which the fourth magnetic body and the fifth magnetic body are magnetized in a direction opposite to the original magnetizing direction due to the leakage magnetic flux.

It should be noted that the present invention is not limited to the features described above, and various configurations can be adopted therein without departing from the essence and gist of the present invention.

What is claimed is:

1. A magnetizing device configured to magnetize a plurality of magnetic bodies, by applying, with respect to a rotor having a plurality of magnetic bodies arranged in a circumferential direction, a magnetic field in a diametrical direction of the rotor, the magnetizing device comprising;
a first magnetizing coil arranged in facing relation to an outer circumferential surface of the rotor, and configured to cause a diametrical outwardly directed first magnetic field to be generated;
a second magnetizing coil arranged in facing relation to the outer circumferential surface of the rotor, and configured to cause a diametrical inwardly directed second magnetic field to be generated;
a third magnetizing coil arranged in facing relation to the outer circumferential surface of the rotor, and configured to cause a diametrical inwardly directed third magnetic field to be generated;
a first auxiliary coil arranged between the first magnetizing coil and the second magnetizing coil in facing relation to the outer circumferential surface of the rotor, and configured to cause a diametrical inwardly directed first auxiliary magnetic field to be generated; and
a second auxiliary coil arranged between the first magnetizing coil and the third magnetizing coil in facing relation to the outer circumferential surface of the rotor, and configured to cause a diametrical inwardly directed second auxiliary magnetic field to be generated;
wherein, by the first magnetizing coil drawing in with the first magnetic field a composite magnetic field which is a composite of the second magnetic field and the third magnetic field, among the plurality of magnetic bodies, a first magnetic body facing toward the first magnetizing coil is magnetized in a diametrical outward direction, a second magnetic body facing toward the second magnetizing coil is magnetized in a diametrical inward direction, and a third magnetic body facing toward the third magnetizing coil is magnetized in a diametrical inward direction;
among magnetic fluxes caused by the second magnetic field and the third magnetic field, a magnetic flux that is not drawn in by the first magnetic field is a diametrical outwardly directed leakage magnetic flux;
on both sides of the first magnetic body along the circumferential direction, a fourth magnetic body and a fifth magnetic body are adjacent to the first magnetic body while sandwiching the first magnetic body therebetween;
with respect to the fourth magnetizing body, the first auxiliary coil allows passage of a diametrical inwardly directed magnetic flux caused by the first auxiliary magnetic field; and
with respect to the fifth magnetizing body, the second auxiliary coil allows passage of a diametrical inwardly directed magnetic flux caused by the second auxiliary magnetic field.

2. The magnetizing device according to claim 1, wherein an electrical current flows respectively in the first auxiliary coil and the second auxiliary coil in a direction opposite to a direction of the electrical current flowing in the first magnetizing coil.

3. The magnetizing device according to claim 1, wherein:
the first auxiliary coil faces toward the fourth magnetic body in a manner so that an axial line of the first auxiliary coil points in the diametrical direction; and
the second auxiliary coil faces toward the fifth magnetic body in a manner so that an axial line of the second auxiliary coil points in the diametrical direction.

4. The magnetizing device according to claim 3, wherein:
the plurality of magnetic bodies each extend respectively in an axial direction of the rotor; and
each of the first auxiliary coil and the second auxiliary coil includes:
a first straight line portion extending in the axial direction;
a second straight line portion arranged to be spaced apart in the circumferential direction with respect to the first straight line portion, and which extends in the axial direction;
a first connecting portion extending in the circumferential direction, and connecting one end of the first straight line portion and one end of the second straight line portion; and
a second connecting portion extending in the circumferential direction, and connecting another end of the first straight line portion and another end of the second straight line portion;
wherein a length of the first connecting portion and a length of the second connecting portion along the circumferential direction are shorter than a length of the first straight line portion and a length of the second straight line portion along the axial direction.

5. The magnetizing device according to claim 4, wherein the length of each of the first connecting portion and the second connecting portion is shorter than a radius of the rotor.

6. The magnetizing device according to claim 1, wherein:
the first auxiliary coil faces toward the fourth magnetic body in a manner so that an axial line of the first auxiliary coil points in a tangential direction of the outer circumferential surface of the rotor; and
the second auxiliary coil faces toward the fifth magnetic body in a manner so that an axial line of the second auxiliary coil points in a tangential direction of the outer circumferential surface of the rotor.

7. The magnetizing device according to claim 6, wherein:
the plurality of magnetic bodies each extend respectively in an axial direction of the rotor; and
each of the first auxiliary coil and the second auxiliary coil includes:
a first straight line portion extending in the axial direction;
a second straight line portion arranged to be spaced apart in the diametrical direction with respect to the first straight line portion, and which extends in the axial direction;
a first connecting portion extending in the diametrical direction, and connecting one end of the first straight line portion and one end of the second straight line portion; and
a second connecting portion extending in the diametrical direction, and connecting another end of the first straight line portion and another end of the second straight line portion;
wherein a length of the first connecting portion and a length of the second connecting portion along the diametrical direction is shorter than a length of the first straight line portion and a length of the second straight line portion along the axial direction.

8. The magnetizing device according to claim 1, wherein a magnitude of the first auxiliary magnetic field and the second auxiliary magnetic field is smaller than a magnitude of the first magnetic field, the second magnetic field, and the third magnetic field.

9. The magnetizing device according to claim 1, further comprising:
a control unit configured to supply an electrical current to the first magnetizing coil, the second magnetizing coil, the third magnetizing coil, the first auxiliary coil, and the second auxiliary coil;
wherein the first magnetizing coil, the second magnetizing coil, the third magnetizing coil, the first auxiliary coil, and the second auxiliary coil are electrically connected in series with respect to the control unit.

10. A magnetizing method of magnetizing a plurality of magnetic bodies, by applying, with respect to a rotor having a plurality of magnetic bodies arranged in a circumferential direction, a magnetic field in a diametrical direction of the rotor, the magnetizing method comprising;
an arrangement step of arranging a first magnetizing coil, a second magnetizing coil, a third magnetizing coil, a first auxiliary coil, and a second auxiliary coil in facing relation to an outer circumferential surface of the rotor; and
a magnetizing step in which, by the first magnetizing coil causing a diametrical outwardly directed first magnetic field to be generated, the second magnetizing coil causing a diametrical inwardly directed second magnetic field to be generated, the third magnetizing coil causing a diametrical inwardly directed third magnetic field to be generated, and by the first magnetizing coil drawing in with the first magnetic field a composite magnetic field which is a composite of the second magnetic field and the third magnetic field, among the plurality of magnetic bodies, a first magnetic body facing toward the first magnetizing coil is magnetized in a diametrical outward direction, a second magnetic body facing toward the second magnetizing coil is magnetized in a diametrical inward direction, and a third magnetic body facing toward the third magnetizing coil is magnetized in a diametrical inward direction;
in the arrangement step, on both sides of the first magnetic body along the circumferential direction, a fourth magnetic body and a fifth magnetic body are placed adjacent to the first magnetic body while sandwiching the first magnetic body therebetween;
among magnetic fluxes caused by the second magnetic field and the third magnetic field, a magnetic flux that is not drawn in by the first magnetic field is a diametrical outwardly directed leakage magnetic flux;
with respect to the fourth magnetizing body, the first auxiliary coil allows passage of a diametrical inwardly directed magnetic flux caused by the first auxiliary magnetic field; and
with respect to the fifth magnetizing body, the second auxiliary coil allows passage of a diametrical inwardly directed magnetic flux caused by the second auxiliary magnetic field.
